(19) United States
(12) Patent Application Publication
(10) Pub. No.: US 2014/0345384 A1
(43) Pub. Date: Nov. 27, 2014

(54) Generator Retaining Ring Scanning Robot

(71) Applicant: Veracity Technology Solutions, LLC, Midwest City, OK (US)

(72) Inventor: Manh Quoc Nguyen, Tulsa, OK (US)

(73) Assignee: Veracity Technology Solutions, LLC, Midwest City, OK (US)

(21) Appl. No.: 14/285,591

(22) Filed: May 22, 2014

Related U.S. Application Data
(60) Provisional application No. 61/826,374, filed on May 22, 2013.

(51) Int. Cl. G01N 29/265; G01N 29/04

(52) U.S. Cl. CPC G01N 29/265; G01N 29/043; G01N 2291/017; G01N 2291/0289; G01N 2291/044; G01N 2291/2634
USPC 73/602

(57) ABSTRACT

A system and method for the inspection of cylindrical components using an ultrasonic transducer assembly. The system and method comprise a robot disposed on a track secured about the circumference of the cylindrical component and adapted to carry the ultrasonic transducer along the track to inspect the component. A computer system is adapted to receive scan data from the transducer assembly and construct a three-dimensional representation of the scanned portion of the component.

### CROSS REFERENCE TO RELATED APPLICATION

This application claims the benefit of provisional patent application Ser. No. 61/826,374, filed on May 22, 2013, the entire contents of which are incorporated herein by reference.

### FIELD

The present invention relates to the field of non-destructive inspection of components and more specifically to an apparatus for the ultrasound inspection of components using a phased array transducer.

### BACKGROUND

The present invention is directed to a robot to inspect generator retaining rings utilizing phased array technology. Current systems utilize conventional Pulse Echo and Time of Flight Diffraction techniques. These systems often implement small transducer sizes requiring longer scanning time while capturing lower resolution. The present invention utilizes tight-pitch phased array technology capable of over one (1) inch scan paths and allows the compilation of the data for three dimensional volumetric representation.

### SUMMARY

The present invention is directed to an apparatus for scanning a cylindrical component having a surface. The device comprises a self-propelled robot having a frame, a track, an arm supported by the frame, a transducer assembly, a controller and a processor. The track is disposed about a circumference of the cylindrical component. The transducer assembly is supported by the arm and movable relative the frame. The assembly comprises a transducer to transmit ultrasonic signals into the component and to receive ultrasonic echoes, The controller controls movement of the frame along the track and the transducer assembly relative the frame. The controller is programmed to move the transducer in a scanning path across the surface from a start point to a stop point at a predetermined velocity. The processor is adapted to receive the echoes from the transducer assembly and analyze the echoes to generate a three-dimensional representation of the component to determine a location and size of flaws present in the component.

The present invention is also directed to a method for non-destructive examination of a cylindrical component. The method comprises providing a self-propelled robot comprising a transducer assembly having a transducer biased toward an outer surface of the cylindrical component. A track is positioned about a circumference of the cylindrical component and the robot is placed on the track. The robot is advanced along the track while ultrasonic waves are transmitted into the component. Ultrasonic echoes are received. Each received echo is indicative of an acoustic impedance interface within the component The echoes are transmitted to a computer system and a three-dimensional image of the cylindrical component is constructed using the computer system by combining the echoes.

The present invention is also directed to a system for performing non-destructive examination of a cylindrical component. The system comprises a self-propelled robot comprising a frame and a drive system, a track, a transducer assembly, a controller, an encoding system, and a processor. The track is disposed about a circumference of the cylindrical component and the robot is disposed on the track. The transducer assembly is supported by the frame and comprises a phased array ultrasonic transducer adapted to engage a surface of the cylindrical component and transmit signals into the component and to receive echoes. The controller controls movement of the robot along the track and movement of the transducer along the surface of the cylindrical component. The encoding system tracks movement of the robot along the track. The processor is adapted to receive echoes received by the transducer and analyze the echoes to generate a three-dimensional representation of the component to determine a location and size of flaws present in the component.

### BRIEF DESCRIPTION OF THE DRAWINGS

FIG. 1 is a diagrammatic view of the scanning robot of the present invention disposed on the surface of a cylindrical component.

FIG. 2 is a top view of the system shown in FIG. 1.

### DESCRIPTION

Non-destructive inspection of components has become an integral service to the maintenance of aircraft fleets and power generation turbines. Current non-destructive testing techniques include visual inspection, eddy current testing, and ultrasonic testing. Current techniques for the ultrasonic testing of components require a service technician to move a hand-held transducer across a surface of the component at a steady rate with near constant pressure. Inaccurate readings may result from the transducer slipping on the surface or changes in the velocity at which the device is moved across the surface. Such difficulties are even more likely when inspecting a component having a cylindrical shape. Such components may include a retaining ring used in turbine engines. Accordingly, there remains a need for improved systems and methods for the ultrasonic testing of components.

The present invention provides a system and method adapted for improved ultrasonic testing of a component such as a cylindrical generator retaining ring. The system of the present invention uses a robot carrying a phased array transducer to scan the surface of the cylindrical component. The echoes received by the transducer are transmitted to a computer system programmed to construct a three-dimensional (“3-D”) rendering of the component showing the presence of any material degradation, defects or flaws in the component.

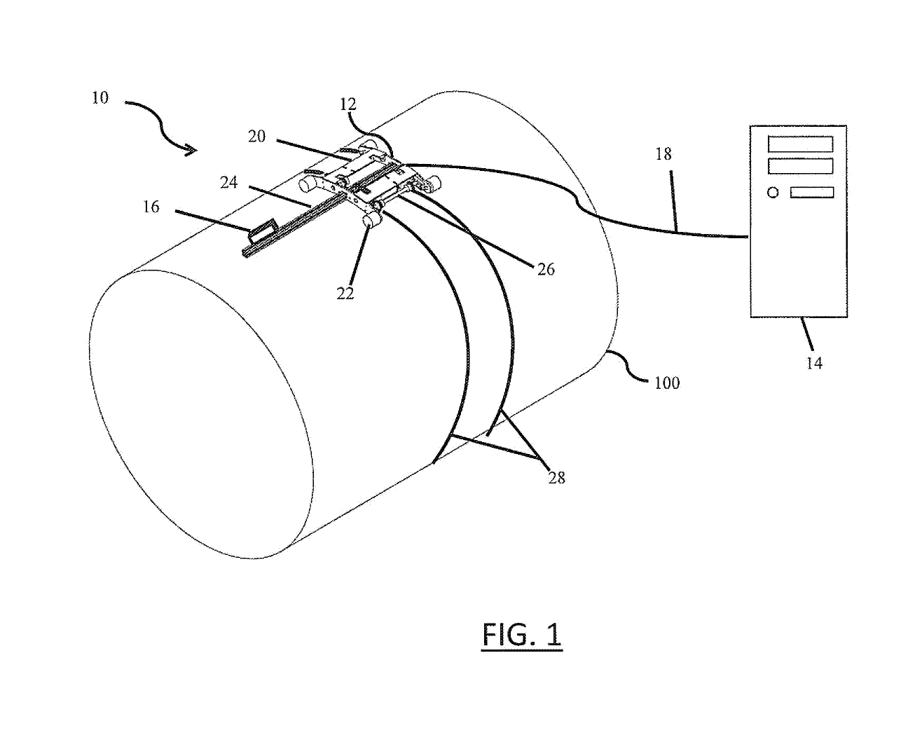

Turning now the Figures and to FIG. 1 in particular, there is shown therein a system 10 for performing non-destructive examination of a component 100. The system 10 comprises a self-propelled robot 12 and a computer system 14 programmed to process data from a transducer assembly 16. The transducer assembly 16, robot 12, and the computer system 14 may be connected via cable 18 to facilitate the transmission of robot commands and scan data between the transducer assembly and the computer system. A power supply (not shown) may supply power to the robot 12 via a power cable. Alternatively, the robot 12 may be powered by an on-board power source (not shown) and wirelessly transmit data from the transducer assembly 16 to the computer 14 via a wireless communications link (not shown).

The computer system 14 comprises a processor adapted to receive echoes from the transducer assembly 16 and analyze the echoes to generate a 3-D representation of the component 100 to determine a location and size of flaws present in the component. The computer system 14 may be remote from the robot 12. One skilled in the art will appreciate that the computer 14 may be supported on the robot 12 to be carried therewith without departing from the spirit of the invention.

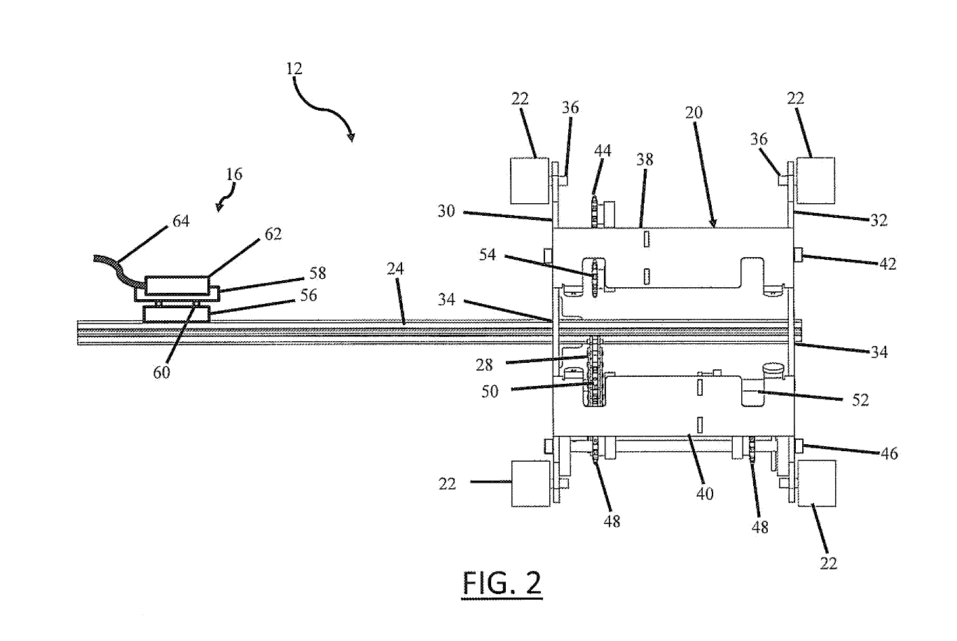

The robot 12 comprises a frame 20, wheels 22 supported on the frame and an arm 24. A drive system 26 is also supported by the frame 20 and is adapted to propel the frame along tracks 28. The drive system 26 will be discussed in more detail hereinafter with reference to FIG. 2. The robot 12 may have a plurality of wheels 22. Wheels 22 allow the robot to roll easily along the surface of the component 100 and also maintain spacing between the robot and the surface. The robot shown in FIG. 1 has four (4) wheels. However, one skilled in the art will appreciate that robots with various numbers of wheels or with endless tracks may be used without departing from the spirit of the invention.

Arm 24 is supported by the frame 20. The arm 24 passes through a pair of holes formed in the frame 20 and extends from the robot in a direction along the length of the cylinder. Arm 24 is used to support the transducer assembly 16 and slides relative the frame 20 to move the transducer assembly 16 closer to or further away from the frame.

Tracks 28 are disposed about a circumference of the cylindrical component. Tracks 28 are secured to the surface of the component 100 and may comprise a pair of chains. In one embodiment tracks 28 may comprise a pair a plastic chains having removable links. Removable links allow the chains to be fit tight against the component with enough slack to allow robot 12 to travel along the tracks. One skilled in the art will appreciate other track configurations such as rails may be utilized without departing from the spirit of the present invention.

Turning now to FIG. 2, the robot 12 is shown in greater detail. The robot 12 shown in FIG. 2 has a frame 20 comprising a first member 30 and a second member 32. The second member 32 is parallel to and spaced apart from the first member 30. Both the first member 30 and the second member 32 comprise holes 34 through which arm 24 passes. As shown in FIG. 1, the bottom of first member 30 and second member 32 may comprise an arc corresponding to the arc of the cylindrical component 100. Wheels 22 are supported on the first member 30 and the second member 32 using axles 36. The first member 30 and second member 32 are connected by first 38 and second 40 span members. The first span member 38 covers an axle 42 that extends between the first member 30 and the second member 32. The axle 42 may support one or more sprockets 44 configured to engage chain 28. In FIG. 2, only a portion of chain 28 is shown.

Axle 46 is shown supported under span member 40 and attached to first member 30 at one end and second member 32 at the other end. Axle 44 supports one or more sprockets 48. A drive sprocket 50 may be operatively connected to a motor 52 also supported under span member 40. The drive sprocket 50 is mostly obscured by chain 28 in FIG. 2. Drive sprocket 50 comprises teeth configured to engage the spaces present in chain 28 to drive movement of the robot 12 along the chain. In operation, the chain 28 is threaded under sprocket 48, over drive sprocket 50, over the arm 24, over sprocket 54, and under sprocket 44.

Continuing with FIG. 2, the transducer assembly 16 of the present invention is shown. The transducer assembly 16 is supported by the arm 24 and adapted to transmit ultrasonic signals into the component 100 (FIG. 1) and to receive ultrasonic echoes. As discussed above, arm 24 is movable relative to frame 20 so that an axial position of the transducer assembly 16 is adjustable to index the transducer 62 to a desired scan line.

The transducer assembly 16 comprises a transducer bracket 56 connectable to the arm 24. The transducer bracket may comprise an L-shaped bracket. A mounting member 58 may be connected to the bracket 56 using a spring biased hinge 60. The mounting member 58 supports the phased array ultrasonic transducer 62. The transducer 62 is generally connected to the mounting member using a non-conductive material. The spring biased hinge 60 comprises a biasing member to bias the transducer 62 toward the surface of the component 100 as the robot 12 is moved along the track 28. Cable 64 is connected to the transducer 62 and carries echoes received by the transducer to the computer system 14.

The transducer assembly 16 is translated along the surface of the component 100 and ultrasonic waves are transmitted into the component. The transducer 62 comprises a phased array ultrasonic probe. The probe 62 may comprise a 128 element array wherein the elements are positioned closely together. A wedge configuration or a delay may be used to control sound angle and distance of penetration of the signal.

The probe 62 utilizes a 128 element probe that may inspect 1″ or more of the surface during a traverse of the surface. The elements (not shown) are positioned and designed to deliver more sensitive inspection results while completing the inspection in less time than other inspection systems.

The system may comprise an on-board processor (not shown) supported by the frame 20 and adapted to autonomously control operation of the robot 12 and accept command, controls from the computer 14 (FIG. 1). The motor 52 is connected to an on-board processor via a wire line connection. The on-board processor may also be connected to the frame 20 using a wire line connection used to transmit movement commands and scan data between the robot and the on-board processor. Further, the on-board processor may be connected to portable computer using communication cables to transmit robot control commands and between the portable computer and the on-board processor. One skilled in the art will appreciate that the on-board processor and portable computer may communicate via a wireless communications link (not shown).

Ultrasonic waves are received as ultrasonic echoes by the transducer assembly 16. Each received echo is indicative of an acoustic impedance interface within the component 100. The echo is captured in the form of an A-scan (RF waveform) and B-scan (sectional view) in a digital image format. With the aid of an image reconstruction program the digital imaging ultrasonic information can be displayed in a 3-D format. By reconstruction of the A-scans with position locations a C-scan (plan view) can also be displayed of the component.

In operation the robot 12 is placed on the surface of the component 100 and the transducer assembly 16 is set, on the desired scan line path. The computer system is programed to cause the transducer assembly to transmit ultrasonic signals into the component and to receive signal echoes at the transducer assembly. The echoes are transmitted to a processor at the computer system 14 and analyzed to generate a three-dimensional representation of the component 100 to determine a location, and size of flaws present in the component. The computer system 14 may also comprise a controller (Not Shown) to control movement of the robot 12 along the track 28. The controller may be programmed to move the transducer 62 in a scanning path across the surface from a start point to a stop point at a predetermined velocity. The controller may move the entire robot 12 along the desired scan path or, alternatively, the controller may cause movement of the arm 24 relative the frame 20 along a scan path. Further, the system 10 may comprises an encoding system to track movement and trigger ultrasonic image capture, The encoding system may comprise an encoder, an encoder wheel to track movement of the robot along the track, and a data acquisition interface. The computer 14 may be programmed to trigger image capture based on a location of the robot 12 and transducer 62 from location information obtained via the encoding system.

In a method of the present invention, a self-propelled robot 12, having a transducer assembly comprising a transducer 62 biased toward an outer surface of the cylindrical component is provided. The track 28 is positioned about the circumference of the cylindrical component and the robot 12 is placed on the track 28 so that the transducer is placed on the surface of the component. Ultrasonic waves are transmitted from the transducer 62 into the component 100. Ultrasonic echoes are received by the transducer and the robot is advanced along the track to the next scanning location. The received echoes are indicative of an acoustic impedance interface within the component. The echoes are transmitted to the computer 14 which constructs a three-dimensional image of the cylindrical component using a computer by combining the echoes. Movement of the robot along the track 28 is recorded to relate received echoes to a location of the robot along the track.

Utilizing multiple ultrasonic data collection images, A-scans, B-scans, C-scans, and reconstructed 3-D formats, a reconstruction of the surface can be performed. These reconstructions may be used to determine the thickness of the surface being investigated. Material loss due to corrosion or mechanical wear can be analyzed from this data. C-scan views and 3-D reconstructions can be utilized to determine areas of metal loss. A-scans can be used to provide specific metal thickness and utilized to evaluate the ultrasonic wave transmission through the material.

Analysis for corrosion can be performed and the component undergoing inspection can be dispositioned in less time than previously required. In addition, all inspection results can be retained in standard formats for historical purposes. Future inspection results can be compared and used in determining the serviceability of the component.

Various modifications can be made in the design and operation of the present invention without departing from the spirit thereof. Thus, while the principle preferred construction and modes of operation of the invention have been explained in what is now considered to represent its best embodiments, which have been illustrated and described, it should be understood that within the scope of the appended claims, the invention may be practiced otherwise than as specifically illustrated and described.

What is claimed is:

1. An system for scanning a cylindrical component having a surface, the system comprising:
a self-propelled robot having a frame;
a track disposed about a circumference of the cylindrical component;
an arm supported by the frame;
a transducer assembly supported by the arm and movable relative the frame, the assembly comprising a transducer to transmit ultrasonic signals into the component and to receive ultrasonic echoes;
a controller for moving the robot along the track and the transducer assembly relative the frame, the controller being programmed to move the transducer in a scanning path across the surface from a start point to a stop point at a predetermined velocity;
a processor adapted to receive the echoes from the transducer assembly and analyze the echoes to generate a three-dimensional representation of the component to determine a location and size of flaws present in the component.

2. The system of claim 1 further comprising a motor adapted to move the robot around the cylindrical component on the track.

3. The system of claim 1 wherein the robot comprises at least one wheel adapted to engage the surface of the component.

4. The system of claim 1 where in the transducer assembly further comprises a biasing member to bias the transducer toward the surface of the component as the robot is moved along the track.

5. The system of claim 1 wherein the transducer assembly comprises:
a transducer bracket operatively connectable to the arm;
a mounting member connected to the transducer bracket;
a phased array ultrasonic transducer supported by the mounting member; and
a biasing member disposed between the transducer bracket and the mounting member to bias the transducer toward the surface of the component as the robot is moved along the track.

6. The system of claim 1 wherein the controller comprises a portable computer supported by the robot.

7. The system of claim 1 wherein the self-propelled robot comprises a drive system to propel the robot along the track.

8. The system of claim 1 further comprising an encoding system, wherein the encoding system comprises:
an encoder;
an encoder wheel to track movement of the robot along the track; and
a data acquisition interface.

9. The system of claim 1 wherein the track comprises a pair of chains having an adjustable length.

10. The system of claim 1 wherein the transducer is movable relative to the frame, such that an axial position of the transducer is adjustable to index the transducer to a desired scan line.

11. A method for non-destructive examination of a cylindrical component, the method comprising:
providing a self-propelled robot comprising a transducer assembly having a transducer biased toward an outer surface of the cylindrical component;
positioning a track about a circumference of the cylindrical component and placing the robot on the track;
advancing the robot along the track to a scanning location;
transmitting ultrasonic waves into the component;
receiving ultrasonic echoes, wherein each received echo is indicative of an acoustic impedance interface within the component;
transmitting the echoes to a computer system; and
constructing a three-dimensional image of the cylindrical component using a computer system by combining the echoes.

12. The method of claim 11 further comprising recording movement of the self-propelled robot along the track to relate received echoes to a location of the robot along the track.

13. The method of claim 11 further comprising biasing the transducer toward the surface of the cylindrical component to maintain contact between the transducer and the component.

14. A system for performing non-destructive examination of a cylindrical component, the system comprising:
a self-propelled robot comprising a frame;
a track disposed about a circumference of the cylindrical component, the robot being disposed on the track;
a transducer assembly supported by the frame comprising a phased array ultrasonic transducer adapted to engage a surface of the cylindrical component and transmit signals into the component and to receive echoes;
a controller for controlling movement of the robot along the track and movement of the transducer along the surface of the cylindrical component;
an encoding system to track movement of the robot along the track; and
a processor adapted to receive echoes received by the transducer and analyze the echoes to generate a three-dimensional representation of the component to determine a location and size of flaws present in the component.

15. The system of claim 14 wherein the robot comprises a plurality of wheels that engage the surface of cylindrical component.

16. The system of claim 14 wherein the track comprises an adjustable chain disposed about the circumference of the cylindrical component, wherein the robot comprises a drive motor and a sprocket operably engaged with the chain and driven by the drive motor to move the robot along the track.

17. The system of claim 14 wherein the controller comprises a portable computer supported by the robot.

18. The system of claim 14 wherein the robot comprises:
a drive motor; and
a track engaging member operable in response to the drive motor to propel the robot along the track.
